(19) United States
(12) Patent Application Publication
(10) Pub. No.: US 2010/0327671 A1
(43) Pub. Date: Dec. 30, 2010

(54) MOTOR CAPABLE OF GENERATING A DRIVING OUTPUT BASED ON A MAGNETIC FIELD

(76) Inventor: Dah-Prong LAI, Taipei County (TW)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 12/823,229

(22) Filed: Jun. 25, 2010

(30) Foreign Application Priority Data
Jun. 29, 2009 (TW) 098121844

(51) Int. Cl. H02K 41/035

(52) U.S. Cl. 310/12.21

(57) ABSTRACT

A motor includes a coil structure disposed between two magnetic plates opposite to each other in a first direction and permitting flow of a current therethrough via opposite current input and output ends. The coil structure includes: parallel magnetic and conductive strips extending in a second direction transverse to the first direction, arranged in a plane transverse to the magnetic plates, and isolated electrically and spatially from each other; and spaced apart non-magnetic and conductive bridging members each interconnecting electrically a corresponding adjacent pair of the strips when the current flows through the coil structure, the motor generates a Lorentz force in a third direction transverse to the first and second directions that is induced by the strips in response to the current flowing through the coil structure and the magnetic field and serves as a driving output of the motor.

### CROSS-REFERENCE TO RELATED APPLICATION

This application claims priority of Taiwanese Application No. 098121844, filed on Jun. 29, 2009.

### BACKGROUND OF THE INVENTION

1. Field of the Invention

The invention relates to a motor, and more particularly to a motor capable of generating a driving output based on a magnetic field.

2. Description of the Related Art

A conventional motor includes a rotor having a permanent magnet, a stator, and a stator coil wound on the stator. The rotor rotates in response a magnetic field induced by a current flowing through the stator coil such that the conventional motor generates a rotary output for driving rotation of an object, such as a propeller. However, although the rotary output generated by the conventional motor can drive rotation of a propeller of an airplane, rotation of the propeller cannot provide a useful driving force for movement of the airplane when in the space.

Therefore, it is desired to design a motor capable of generate a driving output based on a magnetic field, such as the earth's magnetic field.

### SUMMARY OF THE INVENTION

Therefore, an object of the present invention is to provide a motor that can generate a driving output based on a magnetic field.

According to the present invention, there is provided a motor capable of generating a driving output based on a magnetic field in a first direction. The motor comprises:

two magnetic plates opposite to each other in the first direction; and

a coil structure disposed between the magnetic plates and having a current input end adapted to permit flow of a current into the coil structure therethrough, and a current output end opposite to the current input end and adapted to permit flow of the current out of the coil structure therethrough, the coil structure including
a plurality of parallel magnetic and conductive strips arranged in a plane that is transverse to the magnetic plates, and isolated electrically and spatially from each other, each of the strips having first and second ends opposite to each other in a second direction that is transverse to the first direction, the first end of a first one of the strips serving as the current input end of the coil structure, the second end of a last one of the strips serving as the current output end of the coil structure, and
a plurality of non-magnetic and conductive bridging members spaced apart from each other, each of the bridging members interconnecting electrically a corresponding adjacent pair of the strips such that the strips cooperate with the bridging members to constitute the coil structure.

When the current flows through the coil structure, the motor generates a Lorentz force in a third direction transverse to the first and second directions. The Lorentz force is substantially induced by the strips in response to the current flowing through the coil structure and the magnetic field, and serves as the driving output.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing the first preferred embodiment of a motor according to the present invention;

FIG. 2 is an exploded perspective view showing the first preferred embodiment;

FIG. 3 is a schematic top view showing the first preferred embodiment;

FIG. 4 is a schematic front view showing the first preferred embodiment;

FIG. 5 is a perspective view showing the second preferred embodiment of a motor according to the present invention;

FIG. 6 is a fragmentary, partly schematic sectional, perspective view of the second preferred embodiment taken along line VI-VI of FIG. 5; and

FIG. 7 is a perspective view showing the third preferred embodiment of a motor according to the present invention.

### DETAILED DESCRIPTION OF THE PREFERRED EMBODIMENTS

Before the present invention is described in greater detail, it should be noted that like elements are denoted by the same reference numerals throughout the disclosure.

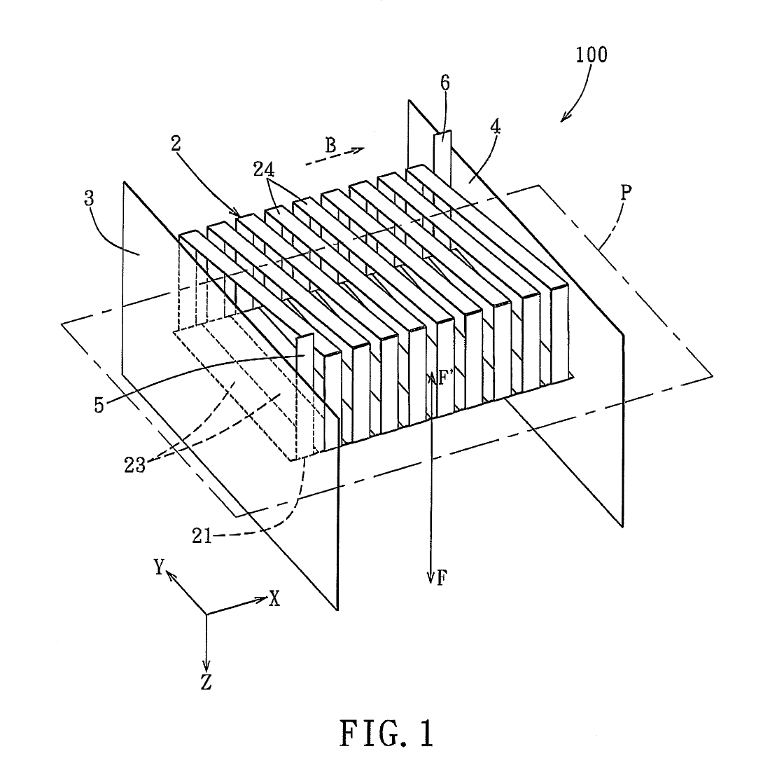

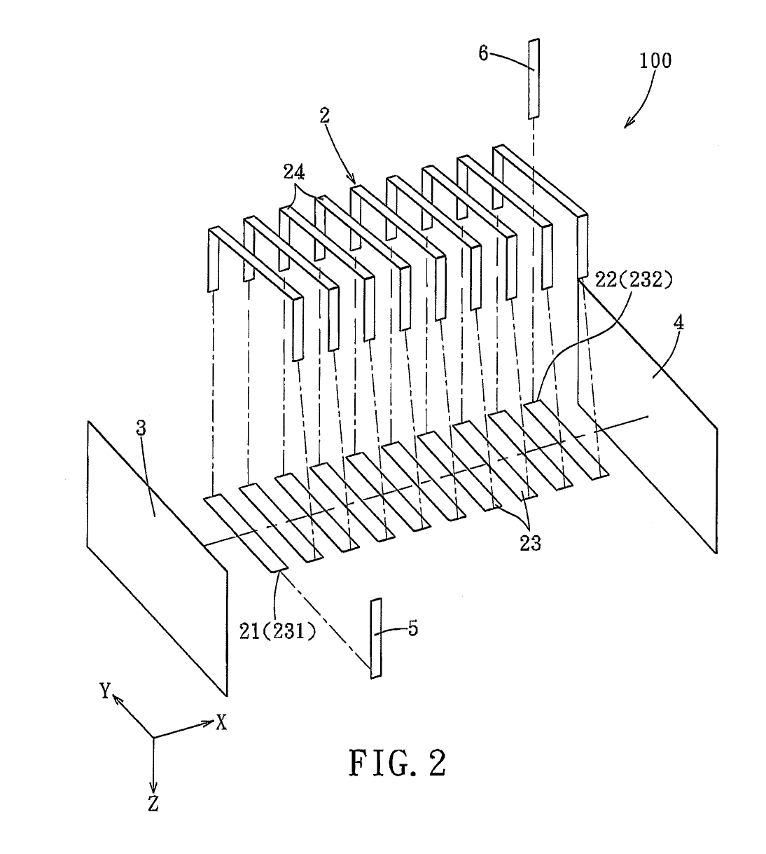

Referring to FIGS. 1 and 2, the first preferred embodiment of a motor 100 according to the present invention is shown. The motor 100 is capable of generating a driving output based on a magnetic field in a first direction (X) indicated by a dotted-line arrow (B) of FIG. 1. The motor 100 includes two magnetic plates 3, 4, a coil structure 2, and first and second conductive sections 5, 6.

The magnetic plates 3, 4 are opposite to each other in the first direction (X). In this embodiment, the magnetic plates 3, 4 are made from a soft magnetic material.

The coil structure 2 is disposed between the magnetic plates 3, 4, and has a current input end 21 and a current output end 22. The current input end 21 is adapted to permit flow of a current into the coil structure 2 therethrough. The current output end 22 is opposite to the current input end 21, and is adapted to permit flow of the current out of the coil structure 2 therethrough. The coil structure 2 includes a plurality of parallel magnetic and conductive strips 23, and a plurality of non-magnetic and conductive inverted U-shaped bridging members 24.

The strips 23 are arranged in a plane (P) that is transverse to the magnetic plates 3, 4, and are isolated electrically and spatially from each other. In this embodiment, the strips 23 are made from a soft magnetic and conductive material, such as permalloy, and are disposed adjacent to each other. Each strip 23 is coated with an insulating layer (not shown), such as insulating paint, such that any two adjacent strips 23 are isolated electrically and spatially from each other. In other embodiments, an insulating member (not shown) can be disposed between any two adjacent strips 23 for electrical and spatial isolation. Each strip 23 has first and second ends 231, 232 opposite to each other in a second direction (Y) transverse to the first direction (X). Preferably, the second direction (Y) is perpendicular to the first direction (X). The first end 231 of a first one of the strips 23 serves as the current input end 21 of the coil structure 2. The second end 232 of a last one of the strips 23 serves as the current output end 22 of the coil structure 2.

The bridging members 24 are spaced apart from each other. Each bridging member 24 interconnects electrically a corresponding adjacent pair of the strips 23 such that the strips 23 cooperate with the bridging members 24 to constitute the coil structure 2. In this embodiment, each bridging member 24 is made from copper, and has opposite ends connected electrically and respectively to the second end 232 of a corresponding strip 23 and the first end 231 of one strip 23 adjacent to the corresponding strip 23 in the first direction (X).

The first conductive section 5 is connected electrically to the current input end 21 of the coil structure 2 such that the coil structure 2 receives the current through the first conductive section 5.

The second conductive section 6 is connected electrically to the current output end 22 of the coil structure 2 such that the coil structure 2 outputs the current through the second conductive section 6.

When the current flows through the coil structure 2, magnetic current generated based on the magnetic field flows through the magnetic plate 3, the strips 23 and the magnetic plate 4 because the magnetic plates 3, 4 and the strips 23 have much smaller magnetic reluctance compared to the bridging members 24. As a result, the strips 23 are induced to generate a first Lorentz force (indicated by a solid-line arrow (F) of FIG. 1) in a third direction (Z) that is perpendicular to the first and second directions (X, Y). The bridging members 24 are induced to generate a second Lorentz force (indicated by a solid-line arrow (F′) of FIG. 1) in a direction opposite to the third direction (Z). Since the magnitude of the first Lorentz force is much greater than that of the second Lorentz force, a Lorentz force generated by the motor 100 based on the magnetic field and the current flowing through the coil structure 2 and serving as the driving output is equal to a vector sum of the first and second Lorentz forces, and is substantially the first Lorentz force induced by the strips 23 in response to the current flowing each strip 23 and the magnetic field.

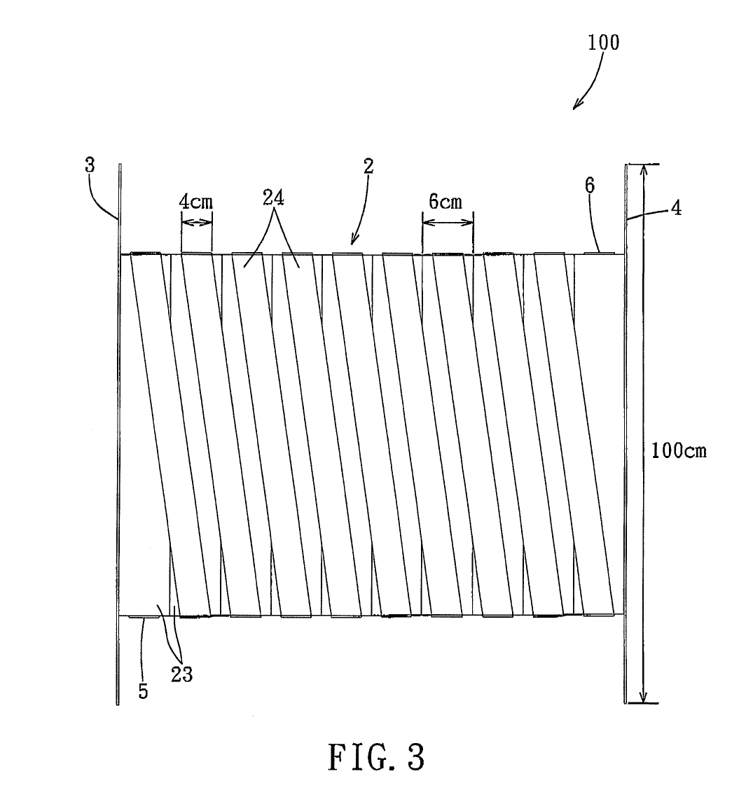

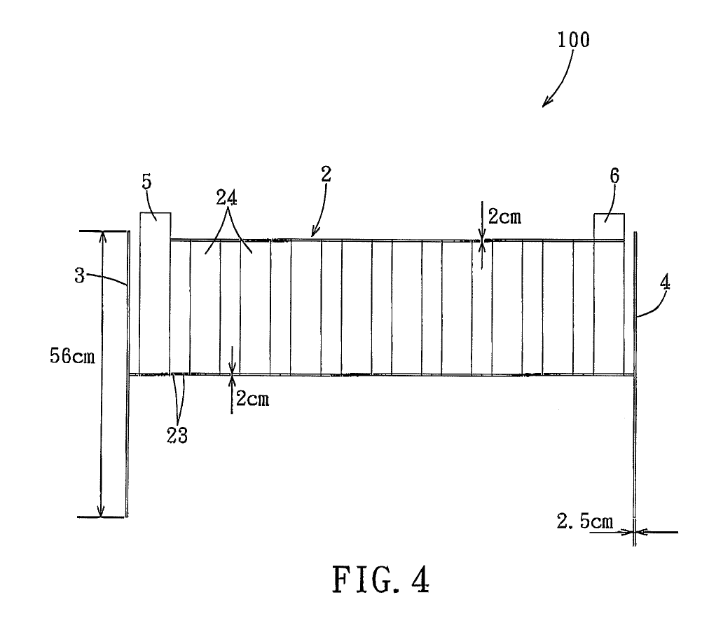

FIGS. 3 and 4 illustrate an example of the motor 100, wherein each of the magnetic plates 3, 4 has a size of 100 cm in the second direction (Y) (see FIG. 3), has a size of 56 cm in the third direction (Z) (see FIG. 4), and a thickness of 2.5 cm (see FIG. 4). The strips 23 have a width of 6 cm, and the bridging members 24 have a width of 4 cm, as shown in FIG. 3. The strips 23 and the bridging members 24 have a thickness of 2 cm, as shown in FIG. 4. In this example, the coil structure 2 includes ten strips 23 and nine bridging members 24, and the earth's magnetic field serves as the magnetic field. According to this example, experimental results of the first Lorentz force, the second Lorentz force and the driving output relative to different currents are shown in Tables 1 to 3, respectively.

TABLE 1

| current (A/m^{²}) | first Lorentz force (N) |
|---|---|
| 1 | 5.27E−05 |
| 10 | 5.25E−04 |
| 100 | 5.10E−03 |

TABLE 2

| current (A/m^{²}) | second Lorentz force (N) |
|---|---|
| 1 | −6.08E−08 |
| 10 | −5.83E−07 |
| 100 | −6.11E−06 |

TABLE 3

| current (A/m^{²}) | driving output (gw) |
|---|---|
| 1 | 5.38E−03 |
| 10 | 5.36E−02 |
| 100 | 5.21E−01 |

In an example application, the motor 100 can be installed in a satellite (not shown) orbiting in the earth space. In this case, the earth's magnetic field can serve as the magnetic field. Thus, by inputting an adequate current to the coil structure 2, the motor 100 of the present invention can thus appropriately generate the driving output that is required for the satellite to increase the speed or change its orbit path. Since the current input to the motor 100 can be supplied from solar cells or batteries (not shown) installed on the satellite, the satellite with the motor 100 of the present invention can avoid fuel exhaustion, thereby prolonging the service life of the satellite.

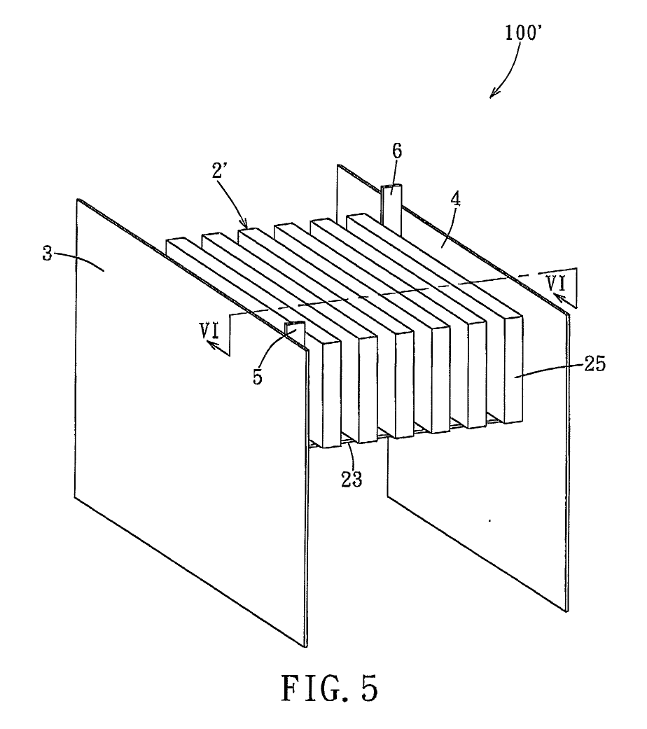

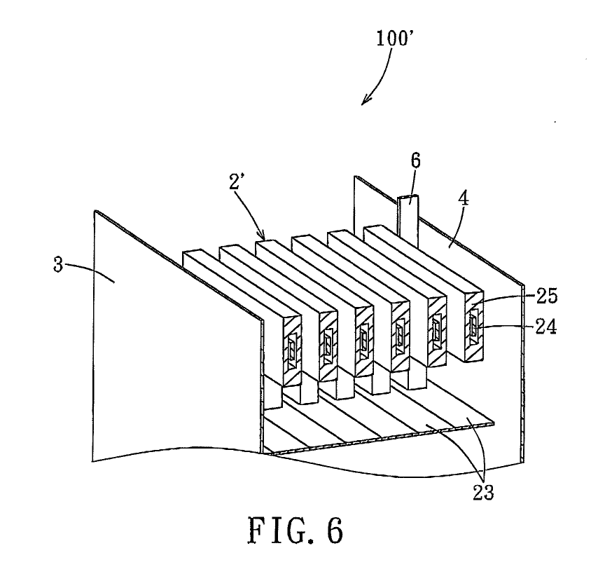

FIGS. 5 and 6 illustrate the second preferred embodiment of a motor 100′ according to this invention, which is a modification of the first preferred embodiment. In this embodiment, the coil structure 2′ further includes a plurality of magnetic tubes 25 sleeved spacedly and respectively on the bridging members 24 such that each bridging member 24 is shielded by a corresponding magnetic tube 25.

For the first preferred embodiment, if a very large current is input to the coil structure 2′, magnetic vortexes induced by the bridging members 24 may incur magnetic saturation of the strips 23, thereby resulting in increased magnetic reluctance of the strips 24 that adversely affects generation of the driving output. In this embodiment, due to the presence of the magnetic tubes 25, magnetic vortexes induced by the bridging members 24 in response to a large current flowing therethrough can be effectively locked in the magnetic tubes 25, thereby avoiding magnetic saturation of the strips 24. Therefore, generation of the driving output can be ensured.

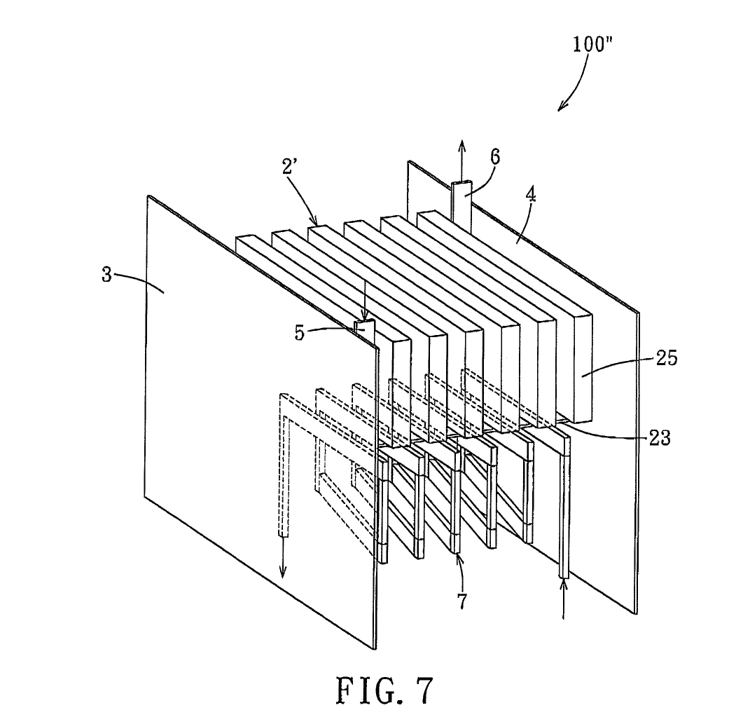

FIG. 7 illustrates the third preferred embodiment of a motor 100″ according to this invention, which is a modification of the second preferred embodiment. In this embodiment, the motor 100″ further includes a reverse coil 7. The reverse coil 7 is mounted between the magnetic plates 3, 4, is disposed spacedly adjacent to the strips 23 of the coil structure 2′, and is opposite to the bridging members 24 in the third direction (Z). The reverse coil 7 is adapted to permit flow of a current therethrough in a direction, such as a counterclockwise direction, opposite to that of the current flowing through the coil structure 2′, such as a clockwise direction. Magnetic vortexes induced by the reverse coil in response to the current flowing therethrough can balance the magnetic vortexes induced by the bridging members 24, thereby ensuring generation of the driving output.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A motor capable of generating a driving output based on a magnetic field in a first direction;
two magnetic plates opposite to each other in the first direction; and
a coil structure disposed between said magnetic plates and having a current input end adapted to permit flow of a current into said coil structure therethrough, and a current output end opposite to said current input end and adapted to permit flow of the current out of said coil structure therethrough, said coil structure including
a plurality of parallel magnetic and conductive strips arranged in a plane that is transverse to said magnetic plates, and isolated electrically and spatially from each other, each of said strips having first and second ends opposite to each other in a second direction that is transverse to the first direction, said first end of a first one of said strips serving as said current input end of said coil structure, said second end of a last one of said strips serving as said current output end of said coil structure, and
a plurality of non-magnetic and conductive bridging members spaced apart from each other, each of said bridging members interconnecting electrically a corresponding adjacent pair of said strips such that said strips cooperate with said bridging members to constitute said coil structure;
wherein, when the current flows through said coil structure, said motor generates a Lorentz force in a third direction transverse to the first and second directions, the Lorentz force being substantially induced by said strips in response to the current flowing through said coil structure and the magnetic field, and serving as the driving output.

2. The motor as claimed in claim 1, wherein the first, second and third directions are perpendicular to each other.

3. The motor as claimed in claim 1, wherein:
said magnetic plates are made from a soft magnetic material; and
said strips are made from a soft magnetic and conductive material.

4. The motor as claimed in claim 3, wherein the soft magnetic and conductive material is permalloy.

5. The motor as claimed in claim 1, wherein said coil structure further includes a plurality of insulating members each disposed between a corresponding adjacent pair of said strips.

6. The motor as claimed in claim 1, wherein each of said strips of said coil structure is coated with an insulating layer.

7. The motor as claimed in claim 6, wherein said insulating layer is in the form of insulating paint.

8. The motor as claimed in claim 1, wherein said coil structure further includes a plurality of magnetic tubes sleeved spacedly and respectively on said bridging members such that each of said bridging members is shielded by a corresponding one of said magnetic tubes.

9. The motor as claimed in claim 1, further comprising a reverse coil mounted between said magnetic plates, disposed spacedly adjacent to said strips of said coil structure, and opposite to said bridging members in the third direction, said reverse coil being adapted to permit flow of a current therethrough in a direction opposite to that of the current flowing through said coil structure.

10. The motor as claimed in claim 1, further comprising:
a first conductive section connected electrically to said current input end of said coil structure such that said coil structure receives the current through said first conductive section; and
a second conductive section connected electrically to said current output end of said coil structure such that said coil structure outputs the current through said second conductive section.
